(19) United States
(12) Patent Application Publication
(10) Pub. No.: US 2024/0067815 A1
(43) Pub. Date: Feb. 29, 2024

(54) POST-CONSUMER RECYCLED THERMOPLASTICS TREATED FOR MELT-PROCESSING WITH ENHANCED QUALITY

(71) Applicants: ColorMatrix Holdings, Inc., Avon Lake, OH (US); Avient Corporation, Avon Lake, OH (US)

(72) Inventors: Mark Rule, Roswell, GA (US); David Rosendale, Bay Village, OH (US); Joshua Otten, Lakewood, OH (US)

(73) Assignees: ColorMatrix Holdings, Inc., Avon Lake, OH (US); Avient Corporation, Avon Lake, OH (US)

(21) Appl. No.: 18/259,866

(22) PCT Filed: Dec. 30, 2021
(86) PCT No.: PCT/US2021/065635

§ 371 Date: Jun. 29, 2023

Related U.S. Application Data
(60) Provisional application No. 63/132,959, filed on Dec. 31, 2020.

(51) Int. Cl. C08L 67/02

(52) U.S. Cl. CPC C08L 67/02; C08L 2666/40; C08L 2666/66

(57) ABSTRACT

Post-consumer recycled polyethylene terephthalate (PCR-PET) flake is treated with chelant to reduce discoloration and generation of non-intentionally added substances (NIAS) upon melt-processing for use in making thermoplastic articles from the PCR-PET flake.

### CLAIM OF PRIORITY

This application claims priority from U.S. Provisional Patent Application Serial Nos. 63/132,959 bearing Attorney Docket Number 1202012-US-F and filed on Dec. 31, 2020, which is hereby incorporated by reference in its entirety.

### FIELD OF THE INVENTION

This invention relates to post-consumer recycled (PCR) thermoplastics including but not limited to polyesters such as polyethylene terephthalate (PET). More particularly, this invention relates to post-consumer recycled polyethylene terephthalate (PCR-PET) flake that is treated for use in making thermoplastic articles by subsequent melt-processing with enhanced quality such as reduced discoloration and lower levels of non-intentionally added substances (NIAS) such as benzene or bisphenol A (BPA) generated relative to untreated PCR-PET flake.

### BACKGROUND OF THE INVENTION

Polyesters, especially polyethylene terephthalate (PET), are versatile polymers that enjoy applicability in a variety of thermoplastic articles such as fibers, films, and three-dimensional structures. A particularly important use of PET is for bottles and containers, especially for food and beverages. This use has seen enormous growth over the last several decades and continues to enjoy increasing popularity.

More recently, demand has grown for food and beverage containers made from at least a portion of post-consumer recycled PET (PCR-PET). Supply of PCR-PET originates primarily from PET bottles collected through one of two routes: either established deposit or redemption programs (deposit PCR-PET) or local curbside recycling programs (curbside PCR-PET). Deposit PCR-PET, which typically is not admixed with other materials or food waste, is generally considered to be higher quality compared to curbside PCR-PET, although the supply of deposit PCR-PET is small compared to curbside PCR-PET. In any event, both deposit PCR-PET and curbside PCR-PET suffer some degree of quality loss relative to virgin PET. Moreover, both are considered contaminated and must undergo thermal decontamination to be considered food-grade material.

Regardless of the collection route, PET bottles go through a complex process of sortation, air elutriation, grinding, screening, and sink-float steps to remove labels, glue, dirt, caps, and different types of polymers such as polyvinyl chloride (PVC). The final PCR-PET product, which is in the form of ground flake, is then washed extensively, dried, and finally decontaminated by heating under vacuum or inert gas. Subsequently, at some point, the PCR-PET flake is melt-processed, usually extruded into pellets. Then, the PCR-PET pellets can be mixed with virgin PET pellets and molded into new thermoplastic articles.

An entire industry, which is devoted to producing PCR-PET material suitable for use in food and beverage containers, has developed. But, throughout this industry, it is widely known that, despite best efforts, the quality of PCR-PET is not as high as that of virgin PET. Some quality issues, such as particulates, have been generally solved by melt-filtration. Other issues, including discoloration and generation of non-intentionally added substances (NIAS) such as benzene or bisphenol A (BPA), remain unaddressed. It is also recognized that these issues are unique to PCR-PET relative to virgin PET. For example, while the color of virgin PET generally increases with each cycle of its heat history (i.e., each occurrence of melt-processing the PET), this increase is trivial compared to the color generated by one heat history of PCR-PET. Similarly, the amount of benzene generated by one heat history of PCR-PET is two to three orders of magnitude greater than that generated by one heat history of virgin PET. The origin of the discoloration and NIAS generation in melt-processed PCR-PET has variously been ascribed to contaminants such as inks, labels, glue, oxygen scavengers, or different polymers such as PVC. Nevertheless, these issues have remained unaddressed.

Consequently, a need exists for PCR-PET, as well as PCR flake of other thermoplastics such as polyolefins including but not limited to polyethylene and polypropylene, that can be melt-processed for use in making thermoplastic articles, especially containers for food and beverages, with enhanced quality as indicated by reduced discoloration or lower levels of generation of NIAS such as benzene or BPA. The aforementioned needs are met by one or more aspects of the disclosed invention.

### SUMMARY OF THE INVENTION

It has now been discovered that treating post-consumer recycled thermoplastics such as PCR-PET flake with chelant capable of chelation with transition metal ions can reduce both discoloration and generation of NIAS such as benzene or BPA upon subsequent melt-processing of the PCR-PET flake. While not intending to be limited by theory, it is believed that inorganic contaminants such as transition metal ions can be present on the surface of PCR-PET flake, and these contaminants can contribute at least in part to the higher levels of discoloration or generation of NIAS such as benzene or BPA that have been observed heretofore upon melt-processing of the PCR-PET flake. By treating the PCR-PET flake with the chelant, the transition metal ions present on the surface of the PCR-PET flake can be made unavailable for the mechanisms responsible for the discoloration and the NIAS generation, for example, by deactivating and/or solubilizing (and washing away) the transition metal ions.

A first aspect of the invention is a mixture including (a) PCR-PET flake, and (b) chelant, wherein the chelant is in physical contact with at least a portion of the PCR-PET flake.

A second aspect of the invention is a method of treating PCR-PET flake for its use in making a thermoplastic article by at least one subsequent melt-processing step. The method includes the steps of: (a) providing the PCR-PET flake; (b) providing chelant; (c) placing the chelant in physical contact with at least a portion of the PCR-PET flake; and (d) optionally, removing at least a portion of the chelant from physical contact with the PCR-PET flake; wherein steps (a), (b) (c), and optionally (d), each occurs prior to the at least one subsequent melt-processing step.

A third aspect of the invention is a method of reducing discoloration during melt-processing of PCR-PET flake. The method includes the steps of: (a) providing the PCR-PET flake; (b) providing chelant; (c) placing the chelant in physical contact with at least a portion of the PCR-PET flake; (d) optionally, removing at least a portion of the chelant from physical contact with the PCR-PET flake; and (e) melt-processing the PCR-PET flake; wherein steps (a), (b), (c), and optionally (d), each occurs prior to step (e).

A fourth aspect of the invention is a method of reducing NIAS generation during melt-processing of PCR-PET flake. The method includes the steps of: (a) providing the PCR-PET flake; (b) providing chelant; (c) placing the chelant in physical contact with at least a portion of the PCR-PET flake; (d) optionally, removing at least a portion of the chelant from physical contact with the PCR-PET flake; and (e) melt-processing the PCR-PET flake; wherein steps (a), (b), (c), and optionally (d), each occurs prior to step (e).

A fifth aspect of the invention is a method of making a thermoplastic article formed (using one or more melt-processing steps) at least in part from PCR-PET flake. The method includes the steps of: (a) providing the PCR-PET flake; (b) providing chelant; (c) placing the chelant in physical contact with at least a portion of the PCR-PET flake; (d) optionally, removing at least a portion of the chelant from physical contact with the PCR-PET flake; and (e) melt-processing the PCR-PET flake to provide (using one or more melt-processing steps) the thermoplastic article; wherein steps (a), (b), (c), and optionally (d), each occurs prior to step (e).

A sixth aspect of the invention is a thermoplastic article formed at least in part from PCR-PET flake, wherein the PCR-PET flake is subjected to melt-processing to form (using one more melt-processing steps) the thermoplastic article, and wherein the PCR-PET flake is placed in physical contact with chelant prior to the melt-processing.

Features of the invention will become apparent with reference to the following embodiments. There exist various refinements of the features noted in relation to the above-mentioned aspects of the disclosed invention. Additional features may also be incorporated in the above-mentioned aspects of the disclosed invention. These refinements and additional features may exist individually or in any combination. For instance, various features discussed below in relation to any of the described aspects of the invention may be incorporated into any of the described aspects of the invention alone or in any combination.

### DETAILED DESCRIPTION OF THE INVENTION

In some embodiments, the invention is directed to mixtures including PCR-PET flake and chelant, wherein the chelant is in physical contact with at least a portion of the PCR-PET flake.

In some embodiments, the invention is directed to methods of treating PCR-PET flake for its use in making a thermoplastic article by at least one subsequent melt-processing step.

In some embodiments, the invention is directed to methods of reducing discoloration during melt-processing of PCR-PET flake.

In some embodiments, the invention is directed to methods of reducing NIAS generation during melt-processing of PCR-PET flake.

In some embodiments, the invention is directed to methods of making a thermoplastic article formed (using one or more melt-processing steps) at least in part from PCR-PET flake.

In some embodiments, the invention is directed to thermoplastic articles formed at least in part from PCR-PET flake, wherein the PCR-PET flake is subjected to melt-processing to form (using one or more melt-processing steps) the thermoplastic article, and wherein the PCR-PET flake is placed in physical contact with chelant prior to the melt-processing.

Required and optional features of these and other embodiments of the disclosed invention are described.

### Terminology

Unless otherwise expressly defined, all technical and scientific terms used herein have the same meaning as commonly understood by a person of ordinary skill in the art.

Unless otherwise expressly stated, it is not intended that any method set forth herein be construed as requiring that its steps be performed in a specific order, nor that any apparatus article set forth herein be construed as requiring specific orders or orientations to its individual components.

Unless otherwise expressly stated, it is intended that any composition or mixture set forth herein can comprise, consist essentially of, or consist of the disclosed ingredients.

As used herein, the singular form of a term is intended to include the plural form of the term, unless the context clearly indicates otherwise.

As used herein, any disclosed numerical value is intended to refer to both exactly the disclosed numerical value and “about” the disclosed numerical value, such that either possibility is contemplated as an embodiment of the disclosed invention, unless the context clearly indicates otherwise.

As used herein, the term “flake” means the form of PCR-PET as produced by grinding post-consumer recycled PET bottles, containers, or the like, as part of conventional post-consumer recycling processes. Generally, without intended to be limiting, the form can be any shape of fragment, piece, chunk, or the like, and implies the PCR-PET is in a solid (i.e., not melted) state.

As used herein, the term “formed from” (including related terms such as “forming”) means, with respect to a thermoplastic article (or component of the article) and a thermoplastic material, that the thermoplastic article (or component of the article) is extruded, molded, shaped, pressed, or otherwise made, in whole or in part, from the thermoplastic material under sufficient heating to enable such forming. As such, the term “formed from” (including related terms such as “forming”) means, in some embodiments, the article (or component of an article) can comprise, consist essentially of, or consist of, the material; and, in other embodiments, the article (or component of an article) consists of the material because the article (or component of an article) is, for example, made by an extrusion process or a molding process. As used herein, the term “formed from” (including related terms such as “forming”) is not intended to be limited to a single forming step or process; rather, it is intended to include one or more forming steps or processes. For example, the term “formed from” can include a first step of extruding a thermoplastic material into pellets followed by a second step of forming the pellets into a thermoplastic article by a forming process such as extrusion, molding, and the like.

As used herein, the term “NIAS” means “non-intentionally added substance” and generally refers to a chemical or substance that is present in an article formed from a thermoplastic material but was not added for a technical reason during the production process. Non-limiting examples of NIAS include hydrocarbons such as benzene and bisphenols such as bisphenol A (BPA).

As used herein, the term “PCR-PET” means post-consumer recycled polyethylene terephthalate. In some instances, the term “rPET” is used to refer to PCR-PET.

PCR-PET Flake and Transition Metal Ions

According to embodiments of the invention, PCR-PET flake is treated with chelant to reduce either discoloration or NIAS generation, or both discoloration and NIAS generation, upon melt-processing of the PCR-PET flake.

Heretofore, a number of mechanisms have been proposed for the appearance of benzene and (separately) color upon melt-processing of PCR-PET. They include decomposition of glues, ink, polystyrene, and PVC present on the PCR-PET, as well as decomposition of the PCR-PET itself by decarboxylation of terephthalic acid moieties. Specific to the decomposition of terephthalic acid moieties, mechanisms proposed include free-radical decarboxylation, acid-catalyzed decarboxylation, base-catalyzed decarboxylation, and transition metal-catalyzed decarboxylation. However, before the present invention, it was unknown which of the above routes were active and/or the relative importance of the various routes. Furthermore, transition-metal decarboxylation was generally not considered as a significant mechanism because virgin PET contains at most low levels of transition metals, and phosphoric acid is traditionally added during PET manufacture to deactivate any trace transition metals that might be present.

While not intending to be limited by theory, it is believed that inorganic contaminants such as transition metal ions can be present on the surface of PCR-PET flake, and these contaminants can contribute at least in part to the higher levels of discoloration and NIAS generation that have been observed heretofore upon melt-processing of the PCR-PET flake.

It is believed these transition metals can come from a variety of sources, including corrosion metals from the PCR-PET processing equipment, debris from the recycling centers and transportation vehicles, and metals from co-mingled recyclate, including printed circuit boards, scrap metal, and rust. That such metal contaminants are present on the surface of PCR-PET is supported by the observation that wastewater sludge from PCR-PET facilities contain iron, chromium, copper, nickel, lead, strontium, and zinc as well as other metals (Energies 2019, 12, 2197; doi:10.3390/en12112197). These and other residues can deposit on the surface of the PCR-PET and be incorporated into the PET matrix upon melt-processing. A number of these metals, such as iron, nickel, and copper are known decarboxylation catalysts for benzoic acid. By contacting the surface of the PCR-PET with chelant prior to melt-processing, these metals can be sequestered and deactivated and hence not be available for decarboxylation reactions and color formation.

Consequently, in some embodiments of the disclosed invention, the PCR-PET flake has a surface and transition metal ions are present on the surface.

Although embodiments of the invention are applied to PCR-PET flake, it is contemplated that the present disclosure is not necessarily limited thereto and the principles of the invention can be applied to other types of post-consumer recycled thermoplastics including but not limited to polyolefins such as polyethylene and polypropylene.

Chelant

Chelant suitable for use in each of the different aspects of invention as disclosed herein includes all chelating agents capable of complexing with transition metal ions.

Suitable chelants may have log K stability constants with transition metal ions that are, in some embodiments, greater than 3, and in some embodiments, greater than 5, and, in some embodiments, greater than 10.

Suitable chelant includes conventional and commercially available chelant.

In some embodiments, chelant is selected from carboxylic acids and salts thereof; phosphoric acids and salts thereof; phosphonic acids and salts thereof; and combinations thereof.

In some embodiments, chelant is selected from ethylenediamine tetraacetic acid (EDTA); phosphoric acid; acetyldiphosphonic acid (ADPA) (CAS No. 2809-21-4); nitrilotris(methylenephosphonic acid) (NTMP) (CAS No. 6419-19-8); diethylenetriamine penta(methylene phosphonic acid) (DTPMP) (CAS No. 15827-60-8); and combinations thereof.

In some embodiments, chelants based on phosphonates and phosphates are preferred because they have a lower propensity to react with PET to form crosslinks and gels.

Chelant may be used as a free acid or as its salts.

The amount of chelant used should be sufficient to, in some embodiments, at least partially, and, in some embodiments, completely complex all transition metals present on the surface of the PCR-PET.

In some embodiments, the chelant is present in an amount from about 1 to about 1000 ppm based on weight of the PCR-PET flake.

In some embodiments, the chelant is present in an amount from about 50 to about 500 ppm based on weight of the PCR-PET flake.

In some embodiments, the chelant is present in an amount from about 100 to about 200 ppm based on weight of the PCR-PET flake.

In some embodiments, chelant is applied to the surface of PCR-PET flake prior to drying and melt extrusion. Accordingly, the function of the chelant is primarily to deactivate the metals present on the surface of the flake.

In some embodiments, chelant is added to the PCR-PET wash water prior to dewatering the PCR-PET flake. Accordingly, the chelant can help solubilize metal ions on the surface of the PCR-PET flake, allowing them to be washed off

Regardless of the mode of contact, chelant should be applied in a manner that is sufficient to, in some embodiments, at least partially, and, in some embodiments, completely wet the surface of the PCR-PET flake.

Wetting the surface of the PCR-PET flake can be accomplished, for example, by immersing the PCR-PET flake in a solution containing the chelant then dewatering the PCR-PET flake, or by spraying the surface of the PCR-PET flake with a solution of the chelant followed by agitation to fully wet the PCR-PET flake surfaces, or by injecting a solution of the chelant into an extruder at a feeding zone that is prior to the polymer melting zone. When the chelant is sprayed onto the PCR-PET flake, the PCR-PET flake can then subsequently be washed, or the chelating agent can be dried onto the surface of the PCR-PET.

In some embodiments, chelant is bonded to, and forms coordination complexes with, at least a portion of the transition metal ions that are present on the surface of the PCR-PET.

In some embodiments, chelant is bonded to, and forms coordination complexes with, substantially all of the transition metal ions.

In some embodiments, the solutions of the chelant are aqueous.

As discussed above, while not intending to be limited by theory, it is believed that inorganic water-borne contaminants such as transition metal ions can be present on the surface of PCR-PET flake. By treating the PCR-PET flake with the chelant, the transition metal ions present on the surface of the PCR-PET flake can be made unavailable for the mechanisms responsible for the discoloration and the NIAS generation, for example, by deactivating and/or solubilizing (and washing away) the transition metal ions.

Additionally, while not intending to be limited by theory, it is believed that washing the PCR-PET flake with a solution of chelant according to the present disclosure can provide a further benefit of opposite pH washing relative to the caustic (alkali) washing which is typically carried out by producers of PCT-PET flake. That is, a slightly acidic wash of a solution of chelant according to the present disclosure can further eradicate contaminants such as adhesives, glues, and other contaminants from the surface of the PCT-PET flake.

Mixtures

In some embodiments, the invention is directed to mixtures including PCR-PET flake and chelant, wherein the chelant is in physical contact with at least a portion of the PCR-PET flake.

In some embodiments, the PCR-PET flake has a surface and the chelant is present only at the surface of the PCR-PET flake. That is, in some embodiments, the chelant is in physical contact with only the surface of the PCR-PET flake, it does not penetrate beyond the surface of the PCR-PET flake, and it is not absorbed into the PCR-PET flake.

In some embodiments, transition metal ions are present on the surface and the chelant is bonded to, and forms coordination complexes with, at least a portion of the transition metal ions.

In some embodiments, the chelant is bonded to, and forms coordination complexes with, substantially all of the transition metal ions.

In some embodiments, the mixture can occur during a batch process of treating PCR-PET flake.

In some embodiments, the mixture can occur during a continuous process of treating PCR-PET flake.

Methods of Treating PCR-PET Flake

In some embodiments, the invention is directed to methods of treating PCR-PET flake for its use in making a thermoplastic article by at least one subsequent melt-processing step.

The method includes the steps of: (a) providing the PCR-PET flake; (b) providing chelant; (c) placing the chelant in physical contact with at least a portion of the PCR-PET flake; and (d) optionally, removing at least a portion of the chelant from physical contact with the PCR-PET flake; wherein steps (a), (b) (c), and optionally (d), each occurs prior to the at least one subsequent melt-processing step.

The physical contact of step (c) can occur, for example, by immersing the PCR-PET flake in a solution containing the chelant then dewatering the PCR-PET flake, or by spraying the surface of the PCR-PET flake with a solution of the chelant followed by agitation to fully wet the PCR-PET flake surfaces, or by injecting a solution of the chelant into an extruder at a feeding zone that is prior to the polymer melting zone.

Regardless of the mode of contact, the physical contact of step (c) continues for a period of time that is sufficient to, in some embodiments, at least partially, and, in some embodiments, completely wet the surface of the PCR-PET flake.

In some embodiments, the physical contact of step (c) continues for less than about 5 minutes, or less than about 2 minutes, or less than about 1 minute.

In some embodiments, the physical contact of step (c) continues for more than about 5 minutes, or more than about 10 minutes, or more than about 15 minutes.

In some embodiments, the physical contact of step (c) continues for a period of time ranging from about 1 second to about 25 minutes.

In some embodiments, the physical contact of step (c) continues for a period of time ranging from about 1 second to about 5 minutes.

In some embodiments, optional step (d) occurs.

In some embodiments, optional step (d) occurs and thereby at least a portion of the transition metal ions is removed from the surface of the PCR-PET flake prior to the melt-processing.

In some embodiments, optional step (d) does not occur and thereby at least a portion of the chelant is not removed from physical contact with the PCR-PET flake prior to the melt-processing.

In some embodiments, the method is a batch process.

In some embodiments, the method is a continuous process.

It should be understood one or more melt-processing steps can be used when making a thermoplastic article by melt-processing in accordance with the disclosed invention. However, in accordance with embodiments of the disclosed invention, the step of placing the chelant in physical contact with at least a portion of the PCR-PET flake occurs prior to the first one of any one or more melt-processing steps.

Methods of Reducing Discoloration

In some embodiments, the invention is directed to methods of reducing discoloration during melt-processing of PCR-PET flake.

In some embodiments, the method includes the steps of: (a) providing the PCR-PET flake; (b) providing chelant; (c) placing the chelant in physical contact with at least a portion of the PCR-PET flake; (d) optionally, removing at least a portion of the chelant from physical contact with the PCR-PET flake; and (e) melt-processing the PCR-PET flake; wherein steps (a), (b), (c), and optionally (d), each occurs prior to step (e).

The physical contact of step (c) can occur, for example, by immersing the PCR-PET flake in a solution containing the chelant then dewatering the PCR-PET flake, or by spraying the surface of the PCR-PET flake with a solution of the chelant followed by agitation to fully wet the PCR-PET flake surfaces, or by injecting a solution of the chelant into an extruder at a feeding zone that is prior to the polymer melting zone.

Regardless of the mode of contact, the physical contact of step (c) continues for a period of time that is sufficient to, in some embodiments, at least partially, and, in some embodiments, completely wet the surface of the PCR-PET flake.

In some embodiments, the physical contact of step (c) continues for less than about 5 minutes, or less than about 2 minutes, or less than about 1 minute.

In some embodiments, the physical contact of step (c) continues for more than about 5 minutes, or more than about 10 minutes, or more than about 15 minutes.

In some embodiments, the physical contact of step (c) continues for a period of time ranging from about 1 second to about 25 minutes.

In some embodiments, the physical contact of step (c) continues for a period of time ranging from about 1 second to about 5 minutes.

In some embodiments, optional step (d) occurs.

In some embodiments, optional step (d) occurs and thereby at least a portion of the transition metal ions is removed from the surface of the PCR-PET flake prior to the melt-processing of step (e).

In some embodiments, optional step (d) does not occur and thereby at least a portion of the chelant is not removed from physical contact with the PCR-PET flake prior to the melt-processing of step (e).

Reduction of discoloration is quantified, in some embodiments, as a Δb* of about 1.0 or more, and, in some embodiments, as a Δb* of about 5.0 or more, and, in some embodiments, as a Δb* of about 10.0 or more.

Methods of Reducing NIAS Generation

In some embodiments, the invention is directed to methods of reducing NIAS generation during melt-processing of PCR-PET flake.

In some embodiments, the method includes the steps of: (a) providing the PCR-PET flake; (b) providing chelant; (c) placing the chelant in physical contact with at least a portion of the PCR-PET flake; (d) optionally, removing at least a portion of the chelant from physical contact with the PCR-PET flake; and (e) melt-processing the PCR-PET flake; wherein steps (a), (b), (c), and optionally (d), each occurs prior to step (e).

The physical contact of step (c) can occur, for example, by immersing the PCR-PET flake in a solution containing the chelant then dewatering the PCR-PET flake, or by spraying the surface of the PCR-PET flake with a solution of the chelant followed by agitation to fully wet the PCR-PET flake surfaces, or by injecting a solution of the chelant into an extruder at a feeding zone that is prior to the polymer melting zone.

Regardless of the mode of contact, the physical contact of step (c) continues for a period of time that is sufficient to, in some embodiments, at least partially, and, in some embodiments, completely wet the surface of the PCR-PET flake.

In some embodiments, the physical contact of step (c) continues for less than about 5 minutes, or less than about 2 minutes, or less than about 1 minute.

In some embodiments, the physical contact of step (c) continues for more than about 5 minutes, or more than about 10 minutes, or more than about 15 minutes.

In some embodiments, the physical contact of step (c) continues for a period of time ranging from about 1 second to about 25 minutes.

In some embodiments, the physical contact of step (c) continues for a period of time ranging from about 1 second to about 5 minutes.

In some embodiments, optional step (d) occurs.

In some embodiments, optional step (d) occurs and thereby at least a portion of the transition metal ions is removed from the surface of the PCR-PET flake prior to the melt-processing of step (e).

In some embodiments, optional step (d) does not occur and thereby at least a portion of the chelant is not removed from physical contact with the PCR-PET flake prior to the melt-processing of step (e).

In some embodiments, the NIAS is benzene, bisphenol A (BPA), and combinations thereof.

In some embodiments, the NIAS is benzene.

Methods of Making Thermoplastic Articles

In some embodiments, the invention is directed to methods of making a thermoplastic article formed (using one or more melt-processing steps) at least in part from PCR-PET flake.

In some embodiments, the method includes the steps of: (a) providing the PCR-PET flake; (b) providing chelant; (c) placing the chelant in physical contact with at least a portion of the PCR-PET flake; (d) optionally, removing at least a portion of the chelant from physical contact with the PCR-PET flake; and (e) melt-processing the PCR-PET flake to provide the thermoplastic article; wherein steps (a), (b), (c), and optionally (d), each occurs prior to step (e).

The physical contact of step (c) can occur, for example, by immersing the PCR-PET flake in a solution containing the chelant then dewatering the PCR-PET flake, or by spraying the surface of the PCR-PET flake with a solution of the chelant followed by agitation to fully wet the PCR-PET flake surfaces, or by injecting a solution of the chelant into an extruder at a feeding zone that is prior to the polymer melting zone.

Regardless of the mode of contact, the physical contact of step (c) continues for a period of time that is sufficient to, in some embodiments, at least partially, and, in some embodiments, completely wet the surface of the PCR-PET flake.

In some embodiments, the physical contact of step (c) continues for less than about 5 minutes, or less than about 2 minutes, or less than about 1 minute.

In some embodiments, the physical contact of step (c) continues for more than about 5 minutes, or more than about 10 minutes, or more than about 15 minutes.

In some embodiments, the physical contact of step (c) continues for a period of time ranging from about 1 second to about 25 minutes.

In some embodiments, the physical contact of step (c) continues for a period of time ranging from about 1 second to about 5 minutes.

In some embodiments, optional step (d) occurs.

In some embodiments, optional step (d) occurs and thereby at least a portion of the transition metal ions is removed from the surface of the PCR-PET flake prior to the melt-processing of step (e).

In some embodiments, optional step (d) does not occur and thereby at least a portion of the chelant is not removed from physical contact with the PCR-PET flake prior to the melt-processing of step (e).

In some embodiments, step (e) includes more than one melt-processing step to provide the thermoplastic article. For example, the PCR-PET flake is extruded into pellets, as a first melt-processing step, and the pellets undergo solid state polymerization (SSP) before being used in a melt-forming process such as molding or extrusion, as a second melt-processing step, to make the end-use thermoplastic article.

In some embodiments, step (e) includes only one melt-processing step to provide the thermoplastic article. For example, the PCR-PET flake is melt-processed in an extruder and directly formed into the end-use thermoplastic article such as a sheet.

In some embodiments, the thermoplastic article is extruded pellets.

In some embodiments, the thermoplastic article is a molded bottle.

Different process steps and routes that can be used to provide thermoplastic articles formed (using one or more melt-processing steps) at least in part from PCR-PET flake are well known to those skilled in the art of thermoplastics polymer engineering. For example, typical process steps and routes are described by European PET Bottle Platform, “PET Recycling Test Protocol: Website version” (September 2017).

Subsequent forming, extrusion, molding, thermoforming, foaming, calendering, and/or other processing techniques are well known to those skilled in the art of thermoplastics polymer engineering. Without undue experimentation but with reference to publications such as “Extrusion, The Definitive Processing Guide and Handbook”, “Handbook of Molded Part Shrinkage and Warpage”, “Specialized Molding Techniques”, “Rotational Molding Technology”, and “Handbook of Mold, Tool and Die Repair Welding”, all part of the Plastics Design Library series published by Elsevier, one can make thermoplastic articles using the principles of the disclosed invention.

Thermoplastic Articles

In some embodiments, the invention is directed to thermoplastic articles formed at least in part from PCR-PET flake, wherein the PCR-PET flake is subjected to melt-processing to form (using one or more melt-processing steps) the thermoplastic article, and wherein the PCR-PET flake is placed in physical contact with chelant prior to the melt-processing.

In some embodiments, the thermoplastic article is extruded pellets.

In some embodiments, the thermoplastic article is a molded bottle.

In some embodiments, the thermoplastic article is formed exclusively from PCR-PET flake treated according to the disclosed invention.

In some embodiments, the thermoplastic article is formed from a blend of at least some virgin PET and at least some PCR-PET treated according to the disclosed invention.

Because PCR-PET flake treated with chelant according to the present invention results in resin with reduced discoloration and lower levels of generation of NIAS such as benzene, food and beverage containers containing PCR-PET can be made with improved color and reduced potential for migration of NIAS such as benzene or BPA into the product. Consequently, higher levels of PCR-PET and lower quality PCR-PET may be utilized for these packages.

Thermoplastic articles such as bottles, containers, sheets, formed parts, fibers, and the like can be made from PCR-PET flake treated with chelant according to the present invention using conventional methods such as injection molding, blow molding, extrusion, thermoforming, fiber spinning, and the like.

### EXAMPLES

The following non-limiting examples illustrate the efficacy of chelants to reduce discoloration and formation of NIAS such as benzene in melt-processed PCR-PET.

In these examples, the benzene content of the PCR-PET was determined by taking a representative portion of the melt-processed polyester, cryogenically grinding to pass a 1 mm screen, placing the PET powder in a sealed vial, and desorbing the contained benzene from the polyester by heating at the designated temperatures and times. The desorbed benzene was then analyzed using a gas chromatograph equipped with a flame ionization detector. The limit of quantification (LOQ) for benzene was 30 ppb. Intrinsic viscosity was measured using phenol/tetrachloroethane as the solvent. Color values are CIE L*. All polymer samples were dried at 175 C for 6 hours prior to melt-processing. Molded plaques were 3 mm thick. In these examples, the term “rPET” is sometimes used to refer to PCR-PET.

### Example 1

PCR-PET resin samples were provided by a commercial PCR-PET recycler located in the United States; the source of the PCR-PET was curbside. PCR-PET flake taken immediately before melt extrusion (variable A), PCR-PET pellets taken immediately after melt extrusion (variable B), PCR-PET pellets taken after solid-state polymerization (variable C), and virgin Indorama 1101 resin (variable D) were tested for benzene content (ppb) at two temperatures (140° C. and 180° C.) and at two test times (40 and 80 minutes). Results are summarized in Table 1.

TABLE 1

| Variable | | 140 C./ | 140 C./ | 180 C./ | 180 C./ |
|---|---|---|---|---|---|
| ID | Variable | 40 min | 80 min | 40 min | 80 min |
| A | rPET flake | <30 | <30 | <30 | <30 |
| B | rPET extruded pellets | 155 | 197 | 437 | 566 |
| C | rPET SSPed pellets | 74 | 107 | 159 | 246 |
| D | Virgin 1101 resin | <30 | <30 | <30 | <30 |

The results summarized in Table 1 show that PCR-PET flake (variable A) prior to melt-processing exhibits no measurable increase in benzene formation relative to virgin PET. In contrast, PCR-PET taken immediately after melt extrusion exhibited elevated levels of benzene under all four test conditions. Substantial levels of benzene were still found in PCR-PET resin that had been solid-state polymerized. The higher levels of benzene seen at 180° C. as compared to 140° C. and between 40 minutes and 80 minutes test time can be attributed to benzene generation during the test, over and above what was present in the as-received resin.

### Example 2

Solid-state polymerized PCR-PET pellets (variable C in Example 1 above) and virgin 1101 resin were treated as summarized in Table 2 to provide variables A through E and injection molded at 275° C. into 15 gram plaques. In all cases, the vehicle was Grinstead's Soft-N-Safe acetylated triglyceride. T6A was tridecyl (6EO) phosphate. ADPA was added as a 60% solution in water. NTMP was added as a 50% solution in water. After treatment, variables C and D were dried overnight to remove excess water. The other variables were treated as already-dried resin. All treatments were mixed thoroughly onto the pellets. All variables were tested for benzene content (ppb) at two temperatures (140° C. and 180° C.) and at one test time (80 minutes). Results are summarized in Table 2.

TABLE 2

| Variable | | 180 C./ | 140 C./ | | |
|---|---|---|---|---|---|
| ID | Variable Description | 80 min | 80 min | Difference | % Reduction |
| A | rPET resin + 500 ppm vehicle | 615 | 341 | 273 | 0.00% |
| B | rPET resin + 500 ppm vehicle + | 602 | 348 | 254 | 7.01% |
| | 500 ppm TSA | | | | |
| C | rPET resin + 500 ppm vehicle + | 535 | 330 | 205 | 24.97% |
| | 500 ppm ADPA solution | | | | |
| D | rPET resin + 500 ppm vehicle + | 548 | 336 | 212 | 22.24% |
| | 500 ppm NTMP solution | | | | |
| E | 1101 + 500 ppm vehicle | <30 | <30 | — | — |

The results summarized in Table 2 show there is little difference in the amount of benzene detected at 140° C./80 minutes for variables A through D. This indicates that the benzene generated during melt extrusion was about the same for all four variables.

However, there are significant differences in the amount of benzene generated at 180° C./80 minutes for variables A through D. This indicates that the rate of benzene generation has been reduced by the addition of the phosphates as chelants.

Moreover, the percent reduction in the rate of benzene generation is substantially greater for the bidentate and tridentate chelating phosphates as compared to the monodentate tridecyl (6EO) phosphate, but still much higher than desired.

Visual inspection of the molded plaques revealed that all of the PCR-PET plaques (variables A through D), regardless of treatment, were a dark yellow-brown in color with no color distinction between them. In contrast, the virgin PET (variable E) plaques were nearly colorless.

These results demonstrate that the use of chelating agents can provide a benefit by reducing the amount of benzene generated during a benzene content test; however, in the context of this particular example, the effect is relatively modest. This modest improvement can be attributed to the fact that the chelant treatments were applied to PCR-PET pellets (i.e., PCR-PET flakes that have been melt-extruded to provide pellets). As such, the transition metals responsible for benzene generation were not only present at the surface but also were already distributed throughout the PET matrix, and the rate at which they can complex with the chelant is slow compared to the timescale of the melt-extrusion process.

These results also demonstrate that addition of chelants after PCR-PET flakes have been melt-processed result in essentially no improvement in the color of the resin. These results are consistent with the benzene results discussed above. These results also are consistent with color formation in PCR-PET being due to metal-catalyzed reactions in the molten PET by unpassivated transition metal contaminants.

### Example 3

PCR-PET flake from Example 1 was ground to pass a 4 mm screen and then was divided into three portions. The first portion was left untreated as a control (variable A). The second portion was surface coated with 0.5% of an aqueous 5% ADPA solution (250 ppm ADPA) to provide variable B. The third portion was surface coated with 0.5% by weight of an aqueous 5% H₃PO₄ solution (250 ppm phosphoric acid) to provide variable C. All three portions were dried and melt extruded at 275° C. to provide amorphous pellets, which were analyzed for benzene content and color. Results are summarized in Table 3.

TABLE 3

| | | 140 C./80 | 180 C./80 | | |
|---|---|---|---|---|---|
| Sample ID | Variable Description | Benzene (ppb) | Benzene (ppb) | L* | b* |
| A | rPET fake Control | 235 | 370 | 49.12 | 5.03 |
| B | rPET flake + 250 ppm ADPA | 169 | 284 | 53.87 | 3.49 |
| C | rPET flake + 250 ppm H3PO4 | 177 | 272 | 51.42 | 3.91 |

The results summarized in Table 3 show that treatment of PCR-PET flake with chelant (either phosphoric acid or ADPA), followed by melt extrusion, resulted in both lower benzene levels and better color (higher L* and lower b*) than the untreated control, with a greater benefit seen with the bidentate ADPA compared to the monodentate phosphoric acid.

### Example 4

Amorphous extruded pellets from each variable in Example 3 were crystallized, solid-stated (under vacuum for 6 hours at 210° C.) and then injection molded at 275° C. into 15 gram plaques. The plaques were analyzed for color. Results are summarized in Table 4.

TABLE 4

| Sample ID | Variable Description | L* | a* | b* |
|---|---|---|---|---|
| A | SSP'ed rPET Control | 69.16 | 0.57 | 25.08 |
| B | SSP'ed rPET + 250 ppm ADPA | 81.38 | −2.08 | 10.51 |
| C | SSP'd rPET + 250 ppm H3PO4 | 79.46 | −1.33 | 13.14 |

The results summarized in Table 4 show that the color values of the treated PCR-PET flake, after melt extrusion, solid-state polymerization, and injection molding into plaques, are markedly better than the untreated resin, not only in reduced yellowness (b*) but also in increased brightness (L*). As before, a greater benefit is seen with the bidentate ADPA compared to the monodentate phosphoric acid. Even greater benefits in color and benzene reduction is expected with polydentate chelating agents.

### Example 5

In this example, the effect of chelant concentration and treatment conditions were examined. PCR-PET flake from Example 1 was ground to pass a 4 mm screen and then was divided into three ˜1500 gram portions. Variable A was surface coated with 125 mL of an aqueous solution containing 0.10 grams ADPA (˜60 ppm ADPA based on the weight of flake). Variable B was surface coated with 125 mL of an aqueous solution containing 0.5 grams ADPA (˜300 ppm ADPA based on the weight of flake). Variable C was placed in a 2 gallon polyethylene bag, to which was added one gallon of distilled water and 0.42 grams of ADPA. After allowing to soak for 15 minutes, the water was drained off and an additional one gallon of distilled water was added. After agitation of the mixture this water was then drained off. All three variables were then dried at 175° C. under vacuum for 6 hours, then injection molded at 275° C. into 15 gram plaques, which then were analyzed for color. Results are summarized in Table 5.

TABLE 5

| Sample ID | Variable Description | L* | a* | b* |
|---|---|---|---|---|
| A | 7.5% ADPA solution + rPET flake (60 ppm ADPA) | 78.43 | −1.30 | 10.67 |
| B | 7.5% ADPA solution + rPET flake (300 ppm ADPA) | 80.92 | −1.87 | 8.40 |
| C | rPET flake (soaked w/250 ppm ADPA & rinsed) | 81.27 | −1.78 | 9.13 |

The results summarized in Table 5, when compared to the results summarized in Table 4, show that the use of greater amounts of water for coating the PCR-PET flake had a beneficial effect on the color of the molded plaques (compare variable B in Table 4 to variable B in Table 5). This beneficial effect likely arises by achieving more complete surface coverage of the PCR-PET flake by the chelant.

These results also demonstrate that greater amounts of chelant resulted in better L* and b* values in the molded plaques (compare variable A in Table 5 to variable B in Table 5).

Lastly, these results demonstrate that all treatment methods were effective in improving the color values of molded plaques compared to the untreated control (variable A in Table 4), and that treating PCR-PET flake with chelant followed by rinsing was as effective as leaving the chelant on the surface of the flake (compare variable B in Table 5 to variable C in Table 5, and variable B in Table 4 to variable C in Table 5).

### Example 6

The following non-limiting example illustrates the efficacy of chelants to reduce formation of NIAS such as BPA in melt-processed PCR-PET.

In this example, two sets of PCR-PET flake were washed by submersion technique. Approximately 10 kg of each flake batch was wash submerged and mixed for 10-15 minutes in 27.5 kg of water. The two sets differed in that the first set (A) was “washed well” using a typical concentration of detergent and the second set (B) was “washed less well” using a lower than typical concentration of detergent.

Each of sets (A) and (B) was split into two batches the first of which was untreated and the second of which was treated with 250 ppm H₃PO₄ active water, thus producing four sample flake batches in total as follows:
(A1) Washed well and untreated;
(A2) Washed well and treated with 250 ppm H₃PO₄ active water;
(B1) Washed less well and untreated; and
(B2) Washed less well and treated with 250 ppm H₃PO₄ active water.

Applicable batches were treated by submergence technique in 250 ppm/wt active H₃PO₄ water solution in order to get an even coating on all surfaces. The flake was then centrifuged @ 800 rpm for 10 minutes. The now damp flake was then dried @ 140° C./4-6 hrs in a closed loop desiccant system prior to extrusion into pellets.

Each flake batch was extruded to produce amorphous pellet which was analyzed for Bisphenol A content. The pellet from each batch was then solid state polymerized at 210° C./6 hrs and the pellets were analyzed for Bisphenol A content. Finally the solid state polymerized pellet for each batch was moulded into a 1 liter 25 g preform, the preform cryo-ground, and the ground sample analyzed for Bisphenol A content.

Results are summarized in Table 6.

TABLE 6

| | Amorphous pellet analysis | | SSP pellet analysis | | 1 litre 25 g ground preform analysis | |
|---|---|---|---|---|---|---|
| | Intrinsic viscocity | Bisphenol A | Intrinsic viscocity | Bisphenol A | Intrinsic viscocity | Bisphenol A |
| | dl/g | (ppm) | dl/g | (ppm) | dl/g | (ppm) |
| Washed well | 0.739 | 0.065 | 0.861 | 1.744 | 0.800 | 0.560 |
| Washed well 250 | 0.730 | 0.07 | 0.893 | 0.162 | 0.820 | 0.065 |
| Washed less well | 0.714 | 0.107 | 0.817 | 1.020 | 0.750 | 0.389 |
| Washed less well 250 | 0.730 | 0.089 | 0.852 | 0.487 | 0.730 | 0.282 |

As shown by the results, the treated batches resulted in a reduction of Bisphenol A generation relative to that of the untreated batches through all thermal processes, even in the “washed well” set.

### Example 7

Commercial curbside washed rPET flake was fed continuously to a twin screw extruder, which was equipped with a feed throat and a vent port, along with a 1% aqueous solution of phosphoric acid. The temperature of the flake at the point of phosphoric acid addition was 90 to 150° C.; the temperature of the flake at the vent port was about 200° C. The feed rate of the rPET flake was 30 lbs/hr, and the feed rate of the phosphoric acid solution was adjusted to achieve 0, 50, 100, and 200 ppm phosphoric acid addition. The extrudate for each variable was pelletized, crystallized, solid-stated, and injection molded into 3 mm plaques.

Table 7 shows the effect of phosphoric acid addition on the b* value of the PET plaques as a function of amount of phosphoric acid added to the rPET flake.

TABLE 7

| ppm phosphoric acid | b* | % reduction |
|---|---|---|
| 0 | 23.030 | 0.0% |
| 50 | 16.493 | 28.4% |
| 100 | 14.316 | 37.8% |
| 200 | 12.237 | 46.9% |

Without undue experimentation, those having ordinary skill in the art can utilize the written description, including the examples, to make and use the disclosed invention.

All documents cited herein are incorporated herein by reference in their entirety unless otherwise specified. The citation of any document is not to be construed as an admission that it is prior art with respect to the disclosed invention.

It will be apparent that modifications and variations are possible without departing from the scope of the disclosure defined in the appended claims. Although some aspects of the present disclosure are identified herein as preferred or particularly advantageous, it is contemplated that the present disclosure is not necessarily limited to these aspects.

1. A mixture comprising:
(a) post-consumer recycled polyethylene terephthalate (PCR-PET) flake; and
(b) chelant;
wherein the chelant is in physical contact with at least a portion of the PCR-PET flake.

2. The mixture of claim 1, wherein the PCR-PET flake has a surface and the chelant is present only at the surface of the PCR-PET flake.

3. The mixture of claim 2, wherein transition metal ions are present on the surface and the chelant is bonded to, and forms coordination complexes with, at least a portion of the transition metal ions.

4. The mixture of claim 3, wherein the chelant is bonded to, and forms coordination complexes with, substantially all of the transition metal ions.

5. The mixture of claim 1, wherein the chelant is present in an amount from about 1 to about 1000 ppm based on weight of the PCR-PET flake.

6. The mixture of claim 1, wherein the chelant is present in an amount from about 50 to about 500 ppm based on weight of the PCR-PET flake.

7. The mixture of claim 1, wherein the chelant is selected from the group consisting of carboxylic acids and salts thereof; phosphoric acids and salts thereof; phosphonic acids and salts thereof; and combinations thereof.

8. The mixture of claim 1, wherein the chelant is selected from the group consisting of ethylenediamine tetraacetic acid (EDTA); phosphoric acid; acetyldiphosphonic acid (ADPA); nitrilotris(methylenephosphonic acid) (NTMP); diethylenetriamine penta(methylene phosphonic acid) (DTPMP); and combinations thereof.

9. A method of treating post-consumer recycled polyethylene terephthalate (PCR-PET) flake for its use in making a thermoplastic article by at least one subsequent melt-processing step, the method comprising the steps of:
(a) providing the PCR-PET flake;
(b) providing chelant;
(c) placing the chelant in physical contact with at least a portion of the PCR-PET flake; and
(d) optionally, removing at least a portion of the chelant from physical contact with the PCR-PET flake;
wherein steps (a), (b) (c), and optionally (d), each occurs prior to the at least one subsequent melt-processing step.

10. The method of claim 9, wherein the PCR-PET flake has a surface and the chelant is present only at the surface of the PCR-PET flake.

11. The method of claim 10, wherein transition metal ions are present on the surface and the chelant is bonded to, and forms coordination complexes with, at least a portion of the transition metal ions.

12. The method of claim 11, wherein the chelant is bonded to, and forms coordination complexes with, substantially all of the transition metal ions.

13. The method of claim 9, wherein the chelant is present in an amount from about 1 to about 1000 ppm based on weight of the PCR-PET flake.

14. The method of claim 9, wherein the chelant is present in an amount from about 50 to about 500 ppm based on weight of the PCR-PET flake.

15. The method of claim 9, wherein the chelant is selected from the group consisting of carboxylic acids and salts thereof; phosphoric acids and salts thereof; phosphonic acids and salts thereof; and combinations thereof.

16. The method of any one of claims 9 to 15 claim 9, wherein the chelant is selected from the group consisting of ethylenediamine tetraacetic acid (EDTA); phosphoric acid; acetyldiphosphonic acid (ADPA); nitrilotris(methylenephosphonic acid) (NTMP); diethylenetriamine penta(methyl ene phosphonic acid) (DTPMP); and combinations thereof.

17. The method of claim 9, wherein the physical contact of step (c) continues for a period of time ranging from about 1 second to about 25 minutes.

18. The method of claim 9, wherein the physical contact of step (c) continues for a period of time ranging from about 1 second to about 5 minutes.

19. The method of claim 9, wherein optional step (d) occurs and thereby at least a portion of the transition metal ions is removed from the surface of the PCR-PET flake prior to the melt-processing.

20. The method of claim 9, wherein optional step (d) does not occur and thereby at least a portion of the chelant is not removed from physical contact with the PCR-PET flake prior to the melt-processing.
